(19) United States
(12) Patent Application Publication
(10) Pub. No.: US 2024/0062924 A1
(43) Pub. Date: Feb. 22, 2024

(54) DEVICE USED TO INSPECT THE CONFINEMENT BOUNDARY OF A VERTICAL SPENT NUCLEAR FUEL STORAGE CANISTER DURING OPERATION

(71) Applicant: Institute of Nuclear Energy Research, Atomic Energy Council, Executive Yuan, R.O.C, Taoyuan (TW)

(72) Inventors: CHING-WEI YANG, Taoyuan (TW); KUEI-JEN CHENG, Taoyuan (TW); YING-WEI LIN, Taoyuan (TW); CHIEN-FU CHEN, Taoyuan (TW)

(21) Appl. No.: 17/968,862

(22) Filed: Oct. 19, 2022

(30) Foreign Application Priority Data
Aug. 16, 2022 (TW) 111130801

(51) Int. Cl. G21C 17/06

(52) U.S. Cl. CPC G21C 17/06

(57) ABSTRACT

A device, which is used to inspect the confinement boundary of a vertical spent nuclear fuel storage canister during operation, includes a vertical spent nuclear fuel storage unit, a lifting unit, a transferring unit and an inspection platform. The vertical spent nuclear fuel storage unit includes a vertical storage canister and a storage overpack. The vertical storage canister is configured for storing spent nuclear fuels, and the storage overpack is configured for storing the vertical storage canister. The lifting unit, connected with the vertical storage canister, is configured for lifting the vertical storage canister. The transferring unit, connected with the lifting unit, is configured for protecting the lifted vertical storage canister. The inspection platform, connected with the transferring unit and the storage overpack, is configured for creating more space with sufficient shielding for the usage of inspecting the confinement boundary of the vertical storage canister.

### CROSS REFERENCE TO RELATED APPLICATION

This application claims the benefits of Taiwan application Serial No. 111130801, filed on Aug. 16, 2022, the disclosures of which are incorporated by references herein in its entirety.

### TECHNICAL FIELD

The present disclosure relates in general to a device for inspecting the confinement boundary of a storage canister, and more particularly to a device used to inspect the confinement boundary of a vertical spent nuclear fuel storage canister during operation.

### BACKGROUND

Restricted by radiation and limited space of a vertical spent nuclear fuel dry storage system, the confinement boundary of the vertical storage canister cannot be inspected effectively during operation through the common and traditional non-destructive testing methods. Prior method for such an inspection, the vertical storage container shall be removed from the storage overpack firstly and then placed into a hot cell or pool. However, removing the vertical storage container from its outer package at storage site is costly and may bring harm to the environment. Besides, such operation needs lots of labor force and increases the personnel's radioactive exposure.

In addition, another method that can perform such inspection at the storage site is utilizing a vehicle with magnetic wheels. The vehicle can be controlled remotely and equipped with a camera. After it drives into the internal limited space through the small openings, the camera installed on it can capture the images of the confinement boundary of a vertical storage canister. However, in the aforementioned method, capturing the complete image data of the confinement boundary would be infeasible due to the limited space inside the storage system.

Nevertheless, in a conventional inspection of the confinement boundary of a horizontal spent nuclear fuel storage canister, a structure frame that is equipped with fixed inspection devices and able to rotate the storage canisters or a rotational plate used to carry inspection devices accompanied with the apparatuses used for transferring operation to perform such confinement boundary inspection. However, this inspection method cannot be applied to the vertical spent nuclear fuel storage canister because the original transferring apparatuses cannot be utilized for such application without being redesigned or significantly modified. Redesigning or significantly modifying theses apparatuses is costly and time consuming. Without redesigning and modifying, the prior art cannot be implemented on the installed ones.

Accordingly, how to provide a “device used to inspect the confinement boundary of a vertical spent nuclear fuel storage canister during operation” without redesigning and modifying the original transferring apparatuses becomes an urgent issue to be resolved in the art.

### SUMMARY

An object of the present disclosure is to provide a device used to inspect the confinement boundary of a vertical spent nuclear fuel storage canister during operation. This device includes a vertical spent nuclear fuel storage unit, a lifting unit, a transferring unit and an inspection platform. The vertical spent nuclear fuel storage unit includes a vertical storage canister and a storage overpack. The vertical storage canister is configured for storing spent nuclear fuels, and the storage overpack is configured for storing the vertical storage canister. The lifting unit, connected with the vertical storage canister, is configured for lifting the vertical storage canister. The transferring unit, connected with the lifting unit, is configured for protecting the lifted vertical storage canister. The inspection platform, connected with the transferring unit and the storage overpack, is configured for creating more space with sufficient shielding for the usage of inspecting the confinement boundary of a vertical storage canister.

In one embodiment of this disclosure, the inspection platform further includes a supporting and shielding structure, a non-destructive testing drive mechanism and a non-destructive testing device. The supporting and shielding structure has a hollow cylindrical inner space. The non-destructive testing drive mechanism is disposed in the supporting and shielding structure. The non-destructive testing device, carried by the non-destructive testing drive mechanism or fixed on the supporting and shielding structure, is configured for inspecting the confinement boundary of a vertical storage canister.

In one embodiment of this disclosure, the non-destructive testing device inspects the confinement boundary of a vertical storage canister in an image-capturing manner.

In one embodiment of this disclosure, the non-destructive testing device inspects the confinement boundary of a vertical storage canister in an Eddy-current-sensing manner.

In one embodiment of this disclosure, the non-destructive testing device is further configured for cleaning the surface of a vertical storage canister.

In one embodiment of this disclosure, the non-destructive testing device is further configured for repairing the surface of a vertical storage canister.

In one embodiment of this disclosure, when a vertical storage canister passes through the hollow cylindrical inner space, the non-destructive testing device is utilized to inspect the confinement boundary of the vertical storage canister.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the device used to inspect the confinement boundary of a vertical spent nuclear fuel storage canister during operation in accordance with this disclosure;

FIG. 2 is a schematic side view of the inspection platform of FIG. 1;

FIG. 3 is a schematic top view of the inspection platform of FIG. 1; and

FIG. 4 is a schematic vertical cross-sectional view of FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

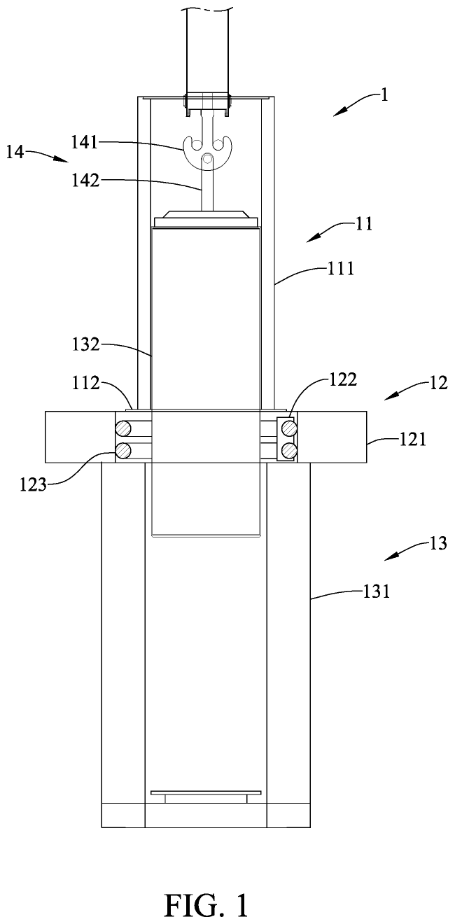

Referring to FIG. 1, a schematic view of an embodiment of the device used to inspect the confinement boundary of a vertical spent nuclear fuel storage canister during operation in accordance with this disclosure is shown. In this embodiment, the device used to inspect the confinement boundary of a vertical spent nuclear fuel storage canister during operation 1 includes a transferring unit 11, an inspection platform 12, a vertical spent nuclear fuel storage unit 13 and a lifting unit 14.

The transferring unit 11, connected with the lifting unit 14, includes a transfer cask 111 and a transfer connector 112. The transferring unit 11, configured for protecting the lifted vertical storage canister 132, is furnished with a hollow cylindrical inner space (not labeled in the figure) for accommodating a vertical storage canister 132. The transfer cask 111 provides mechanical support and radiation shielding. The transfer connector 112 is configured for connecting the transferring unit 11 and the inspection platform 12 and opening or closing the doors (not labeled in the figure) at the bottom of the transfer cask 111.

The inspection platform 12 is connected with the transferring unit 11 by being placed between the transferring unit 11 and the vertical spent nuclear fuel storage unit 13. The inspection platform 12 includes a supporting and shielding structure 121, a non-destructive testing device 122 and a non-destructive testing drive mechanism 123. The inspection platform 12 is configured for creating more shielded space for inspecting the confinement boundary of a vertical storage canister 132.

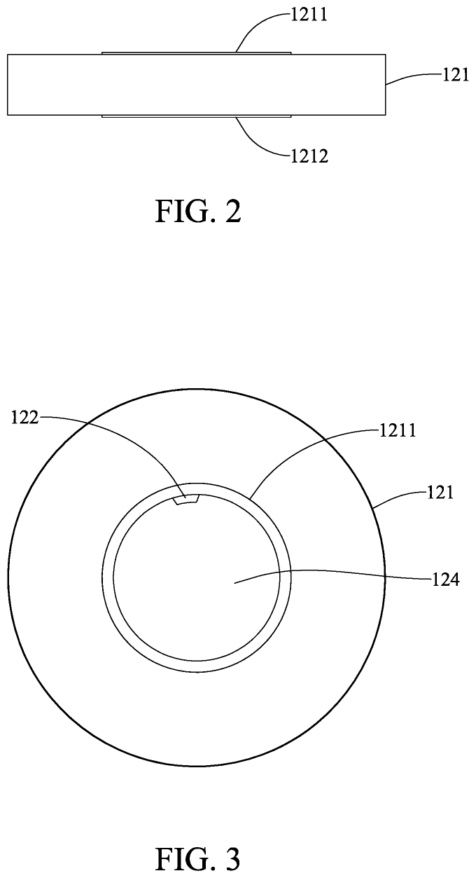

As shown in FIG. 2, the supporting and shielding structure 121 includes a transfer-connector interface structure 1211, which may integrate the function of the transfer connector 112 in it and a storage-overpack interface structure 1212. The transfer-connector interface structure 1211 is configured for connecting with the transfer connector 112 if without integrating the function of the transfer connector 112 in it, and the storage-overpack interface structure 1212 is configured for connecting with the storage overpack 131.

The vertical spent nuclear fuel storage unit 13, connected with the inspection platform 12, includes a storage overpack 131 and a vertical storage canister 132. The storage overpack 131, configured for storing the vertical storage canister 132, is provided with mechanical support and radiation shielding. Similarly, the storage overpack 131 has a hollow cylindrical inner space (not labeled in the figure) configured for storing the vertical storage canister 132.

The lifting unit 14, connected with the vertical storage canister 132, includes a lifting hook 141 and a lifting connector 142. The lifting unit 14 is configured for lifting the vertical storage canister 132. Practically, the lifting connector 142 is connected with the top portion of the vertical storage canister 132, so as to lift the vertical storage canister 132 up and down through the lifting hook 141. In addition, the vertical storage canister 132 is shaped to be a cylindrical container for storing the spent nuclear fuels.

Referring to FIG. 3, a schematic top view of the inspection platform of FIG. 1 is shown. In this embodiment, the supporting and shielding structure 121 has roughly a circular appearance. Similarly, the supporting and shielding structure 121, provided with the functions of mechanical support and radiation shielding, has a hollow cylindrical inner space 124 configured for allowing the vertical storage canister 132 to pass therethrough.

The non-destructive testing device 122 is applied to inspect the confinement boundary of the vertical storage canister 132 in an image-capturing or Eddy-current-sensing manner. In one exemplary example, the non-destructive testing device 122 is capable of enlarging or shrinking an image. For example, the non-destructive testing device 122 can be used to inspect the vertical storage canister 132 through the captured image data to determine if the surface of the vertical storage canister 132 is presented with corrosion, rust spots, breakage, cracks or dents, etc. Since the aforesaid inspection can be remotely performed, the risk of exposing personnel in a higher radioactive environment can be effectively avoided.

It shall be explained that the non-destructive testing device 122 is placed near the hollow cylindrical inner space 124 of the supporting and shielding structure 121. As shown in FIG. 3, during the inspection, the non-destructive testing device 122 can move inward to approach or touch the surface of the vertical storage canister 132. After the inspection is finished, the non-destructive testing device 122 can move back to the initial position. Therefore, the non-destructive testing device 122 would not interfere with the vertical storage canister 132 while the vertical storage canister 132 is moving through the hollow cylindrical inner space 124 or rotating driven by the non-destructive testing drive mechanism 123. In other words, with the aforesaid embodiment provided in this disclosure, the structure and dimensions of the transferring unit 11 and the vertical spent nuclear fuel storage unit 13 do not need to be further modified.

In some embodiments, the non-destructive testing device 122 can be replaced with a brush configured for cleaning the surface of the vertical storage canister 132. In some other embodiments, the non-destructive testing device 122 can be replaced with a device configured for repairing the surface of the vertical storage canister 132.

In another embodiment of this disclosure, an inspection method using the aforesaid device can include the following steps. Firstly, the lifting connector 142 is connected with the vertical storage canister 132, then the inspection platform 12 is placed on the top of the storage overpack 131, further the transferring unit 11 is placed on the top of the inspection platform 12, and finally the lifting hook 141 is connected with the lifting connector 142.

The lifting unit 14 consisted of the lifting hook 141 and the lifting connector 142 would be applied to lift up the vertical storage canister 132 gradually from the storage overpack 131. As the vertical storage canister 132 is lifted up to pass through the inspection platform 12, the non-destructive testing drive mechanism 123 built in the inspection platform 12 would drive the non-destructive testing device 122 to inspect the vertical storage canister 132 or drive the vertical storage canister 132 to rotate and be inspected by the non-destructive testing device 122 or both. Therefore, the condition of the confinement boundary of the vertical spent nuclear fuel storage canister can be checked and inspected.

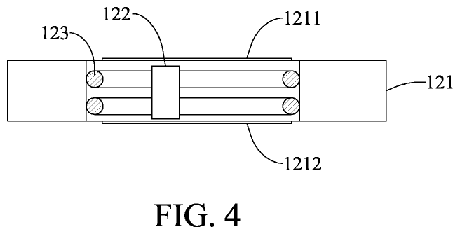

Referring to FIG. 4, a schematic vertical cross-sectional view of FIG. 2 is shown. As illustrated, the non-destructive testing drive mechanism 123, provided with a guiding structure and/or at least a driving wheel, is configured for driving the non-destructive testing device 122 to move in the circumferential direction or driving the vertical storage canister 132 to rotate. Practically, the non-destructive testing drive mechanism 123 can be configured for driving the non-destructive testing device 122 to move circumferentially to inspect the whole surface of the vertical storage canister 132 or rotate the vertical storage canister 132 and the whole surface of the vertical storage canister 132 can be inspected by the non-destructive testing device 122. Therefore, a complete inspection of the confinement boundary of the vertical storage canister 132 can be achieved.

In summary, the device used to inspect the confinement boundary of a vertical spent nuclear fuel storage canister provided in this disclosure can perform on-site inspection on the surface of a vertical storage canister 132 without transporting the vertical storage canister 132 to the hot cell or pool. Hence, the time and risk related to such inspection can be effectively reduced, and the inspection efficiency can be substantially improved.

In addition, by providing the inspection platform of this disclosure, more shielded space can be created for the inspection usage. Through increasing the shielded space for the inspection usage, the condition of the confinement boundary of the vertical storage canister 132 can be fully inspected without redesigning or modifying the existing transferring unit 11 and the vertical spent nuclear fuel storage unit 13. Hence, the economic efficiency and usability of inspecting the condition of the confinement boundary of a vertical storage canister 132 can be substantially improved through this disclosure.

Further, with the inspection platform of this disclosure, the inspection can be remotely performed, such that the personnel's radiation exposure dose can be substantially reduced, and the safety of the inspection can be significantly ensured.

Respecting to the above description, it is to be realized that the optimal geometric relations to the parts of the disclosure including variations in size, materials, shape, form, operational functions, assembly, and applications, are deemed readily apparent and obvious to one skilled in the art, and all equivalent relationships to those illustrated in the drawings and described in the specification are intended to be encompassed by the present disclosure.

What is claimed is:

1. A device used to inspect the confinement boundary of a vertical spent nuclear fuel storage canister during operation, comprising:
a vertical spent nuclear fuel storage unit, including:
a vertical storage canister, configured for storing spent nuclear fuels; and
a storage overpack, configured for storing the vertical storage canister;
a lifting unit, connected with the vertical storage canister, configured for lifting the vertical storage canister;
a transferring unit, connected with the lifting unit, configured for protecting the lifted vertical storage canister; and
an inspection platform, connected with the transferring unit and the storage overpack, configured for creating more shielded space, which can be utilized to perform the inspection of the confinement boundary of the vertical storage canister.

2. The device used to inspect the confinement boundary of a vertical spent nuclear fuel storage canister during operation of claim 1, wherein the inspection platform further includes:
a supporting and shielding structure, having a hollow cylindrical inner space;
a non-destructive testing drive mechanism, disposed in the supporting and shielding structure; and
a non-destructive testing device, carried by the non-destructive testing drive mechanism or fixed on the supporting and shielding structure, configured for inspecting the confinement boundary of the vertical storage canister.

3. The device used to inspect the confinement boundary of a vertical spent nuclear fuel storage canister during operation of claim 2, wherein the non-destructive testing device inspects the confinement boundary of the vertical storage canister in an image-capturing manner.

4. The device used to inspect the confinement boundary of a vertical spent nuclear fuel storage canister during operation of claim 2, wherein the non-destructive testing device inspects the confinement boundary of the vertical storage canister in an Eddy-current-sensing manner.

5. The device used to inspect the confinement boundary of a vertical spent nuclear fuel storage canister during operation of claim 2, wherein the non-destructive testing device is further configured for cleaning the surface of the vertical storage canister.

6. The device used to inspect the confinement boundary of a vertical spent nuclear fuel storage canister during operation of claim 2, wherein the non-destructive testing device is further configured for repairing the surface of the vertical storage canister.

7. The device used to inspect a confinement boundary of a vertical spent nuclear fuel storage canister during operation of claim 2, wherein, when the vertical storage canister passes through the cylindrical inner space, the non-destructive testing device is utilized to inspect the confinement boundary of the vertical storage canister.
